(19) United States
(12) Patent Application Publication
(10) Pub. No.: US 2011/0034132 A1
(43) Pub. Date: Feb. 10, 2011

(54) Systems and Methods for Minimizing Electromagnetic Interface

(75) Inventor: Daniel Babitch, San Jose, CA (US)

Correspondence Address: SIRF Technology, Inc.,;c/o Duane Morris LLP, 1180 West Peachstree Street, NW, Suite 700, Atlanta, GA, 30309-3448, US

(73) Assignee: SIRF Technology Inc., San Jose, CA (US)

(21) Appl. No.: 12/537,295

(22) Filed: Aug. 7, 2009

(51) Int. Cl. H04B 1/40

(52) U.S. Cl. 455/76

(57) ABSTRACT

Systems and methods for minimizing electromagnetic interference are provided. A representative electronic device includes a frequency generator that generates clock signals and a computing device that selects at least one generator frequency that minimizes or eliminates electromagnetic interference based on one or more radio bands of interest. The computing device is designed to send instructions associated with synthesizing the at least one generator frequency. The electronic device further includes a frequency synthesizer that receives the generated clock signals and instructions from the frequency generator and the computing device, respectively. The frequency synthesizer synthesizes the at least one generator frequency based on the received clock signal.

### TECHNICAL FIELD

The present disclosure is generally related to electronic devices and, more particularly, is related to systems and methods for minimizing electromagnetic interface in electronic devices having with at least one radio circuitry.

### BACKGROUND

Switching voltage regulators have substantial ability to cause interference in radio receivers. Some of the primary causes of switching regulator interference are the following:
(a) Switching frequency or harmonics or spurious oscillations which fall into radio receiver bands and are coupled to the radio antenna input circuit by parasitic coupling.
(b) Magnetic fields generated by switching regulator currents are poorly confined.
(c) Voltage ripple from the switching regulator interferes with the radio circuits which it is powering.

Previous techniques for minimizing EMI (electromagnetic interference) include spread spectrum modulation of the switching waveform, and FM modulation which is similar in effect. These techniques are said to minimize EMI, but in fact, they typically minimize the peak power spectral density in exchange for allowing the EMI spectrum to have spread bandwidth. The total switching EMI power is not changed. Previous techniques are useful if the radio to be used has a signal bandwidth which is much narrower than the spreading bandwidth of the switching regulator, which is not always the case. For example, GPS, CDMA, Bluetooth, WCDMA, and Wi-Fi in all its variants all typically have signal bandwidth which is largely incompatible with those techniques, and thus, avoidance may be more appropriate.

### SUMMARY

Systems and methods for minimizing electromagnetic interference are provided. A representative electronic device includes a frequency generator that generates clock signals and a computing device that selects at least one generator frequency that minimizes or eliminates electromagnetic interference based on one or more radio bands of interest. The computing device is designed to send instructions associated with synthesizing at least one generator frequency. The electronic device further includes a frequency synthesizer that receives the generated clock signals and instructions from the frequency generator and the computing device, respectively. The frequency synthesizer synthesizes at least one generator frequency based on the received clock signal and instructions.

Other systems, devices, methods, features of the invention will be or will become apparent to one skilled in the art upon examination of the following figures and detailed description. It is intended that all such systems, devices, methods, and features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a block diagram that illustrates an embodiment of a system having a target device that controls a frequency synthesizer to minimize electromagnetic interference;

FIG. 2 is a block diagram that illustrates an embodiment of a target device, such as that shown in FIG. 1, which includes a frequency selection manager that facilitates controlling a frequency synthesizer;

FIG. 3 is a power-versus-frequency chart that illustrates electromagnetic interference as a result of poor selection of generator frequency that a target device 120 can detect according to one embodiment of the disclosure;

FIG. 4 is a power-versus-frequency chart that illustrates minimum (or zero) electromagnetic interference as a result of good selection of generator frequency in which a target device minimized or eliminated the electromagnetic interference using a frequency selection manager, such as that shown in FIG. 2;

FIG. 5 is a signal power-versus-frequency chart that illustrates minimum (or zero) electromagnetic interference as a result of good selection of generator frequency in which a target device has selected frequencies to fall into spectral nulls of a radio signal spectrum using a frequency selection manager, such as that shown in FIG. 2;

FIG. 6 is a high-level flow diagram that illustrates an embodiment of the architecture, functionality, and/or operation of a frequency selection manager, such as that shown in FIG. 2, that selects a frequency to minimize electromagnetic interference;

FIGS. 7A-B are flow diagrams that illustrate an embodiment of the architecture, functionality, and/or operation of a frequency selection manager, such as that shown in FIG. 2; and

FIG. 8 is a block diagram illustrating an exemplary architecture for a target device, such as that shown in FIG. 2.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which electromagnetic interface in electronic devices having at least one radio circuitry is minimized.

This disclosure is relevant to, for example, cell handsets or other radio-based devices. Many such devices include multiple radio circuitries, e.g., cellular, Bluetooth, Wi-Fi, and GPS, several of which may need to operate simultaneously. In such cases, there is a problem of self-interference where one function of the handset, for example, a switching power supply, can interfere with multiple radio functions within the same handset, which can be exacerbated by close physical proximity between the various potentially interfering elements being, for example, within micrometers of each other on the same piece of Silicon or a few centimeters apart.

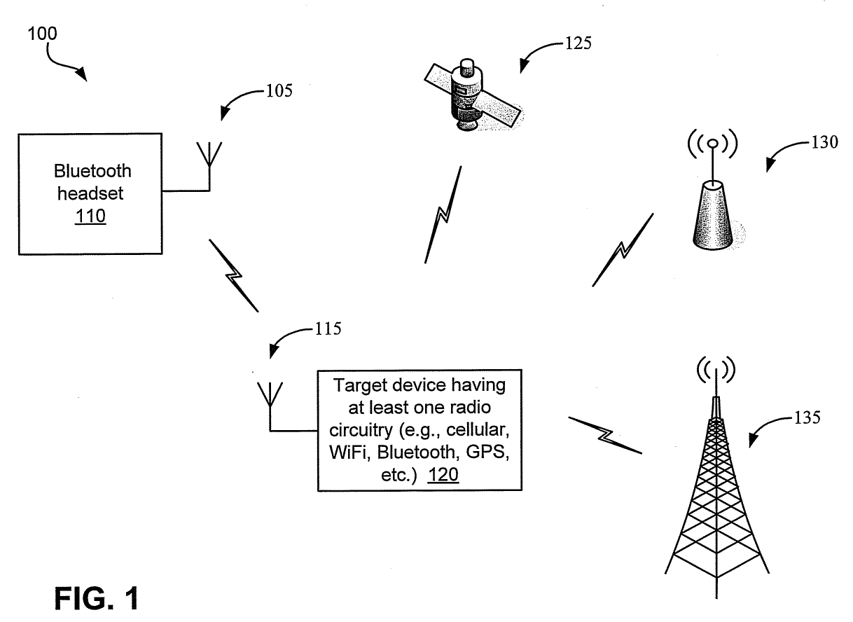

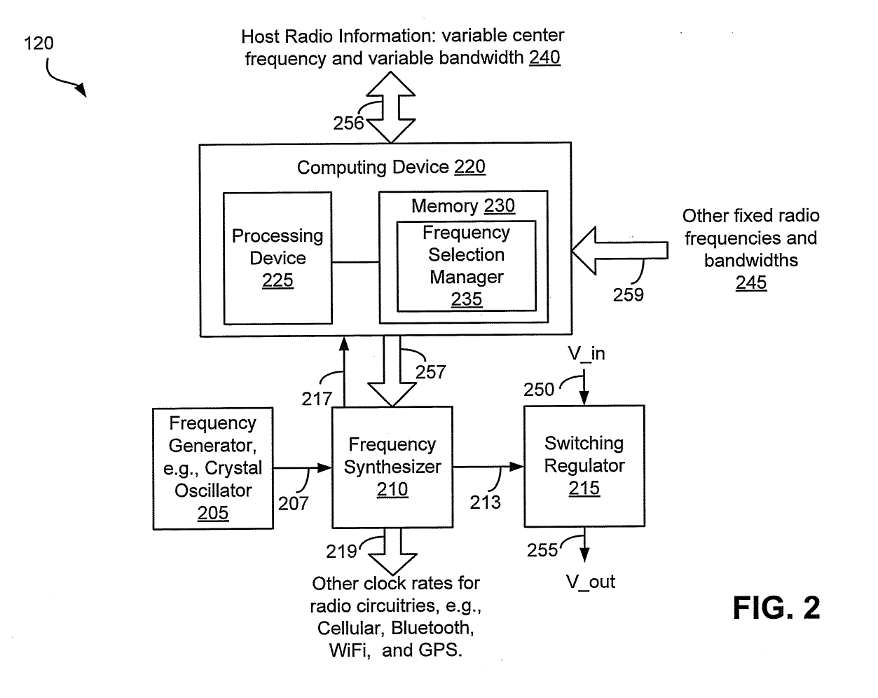

FIG. 1 is a block diagram that illustrates an embodiment of a system 100 having a target device 120 that controls a frequency synthesizer 210 (FIG. 2) to minimize electromagnetic interference. The target device 120 includes, for example, a laptop, cell phone, personal digital assistant (PDA), satellite 125, Bluetooth device, wireless router, global positioning system (GPS) receiver.

The target device 120 can wirelessly communicate with, for example, a Bluetooth headset 110, a satellite 125, a network wireless router 130, and a cellular/radio tower 135 using radio circuitries, such as, Bluetooth transceiver, global positioning system (GPS) receiver, Wi-Fi transceiver, cellular transceiver, frequency modulation (FM) broadcast radio receiver or transmitter, and amplitude modulation (AM) broadcast radio receiver.

Both the Bluetooth headset 110 and the target device 120 include antennas 105, 115, respectively, to facilitates the wireless communication. Although FIG. 1 shows antennas 105, 115 for the Bluetooth headset 110 and the target device 120, one skilled in the art would appreciate that every radio has an antenna. Sometimes two radios can share an antenna, e.g., Bluetooth and Wi-Fi. This example is common because they're usually at the same frequency band. Sometimes one radio may have two antennas, e.g., Wi-Fi 802.11g and-n.

FIG. 2 is a block diagram that illustrates an embodiment of a target device 120, such as that shown in FIG. 1, which includes a frequency selection manager 235 that facilitates controlling a frequency synthesizer 210. The target device 120 includes a frequency generator 205, such as a crystal oscillator, that generates and sends clock signals to the frequency synthesizer 210 via line 207.

A computing device 220 includes a processing device 225 and memory 230 that includes a frequency selection manager 235. The computing device 220 can receive a host radio information 240 having variable center frequency and variable bandwidth and data associated with other fixed radio frequencies and bandwidths 245 via lines 256, 259, respectively, that are used to communicate with the host radio circuitries and other radio circuitries of the target device 120.

The host radio information 240 and fixed radio frequencies and bandwidths 245 are stored in memory 230 as radio bands of interest. Such radio bands of interest can include frequencies associated with, for example, the processing device 225, memory 230, switching regulator 215, cellular transceiver, WiFi transceiver, Bluetooth transceiver, a global positioning system (GPS) receiver, frequency modulation (FM) broadcast radio receiver, and amplitude modulation (AM) broadcast radio receiver. The frequency selection manager 235 can select at least one generator frequency that minimizes or eliminates electromagnetic interference based on one or more radio bands of interest. The computing device 220 is designed to send instructions associated with synthesizing the at least one generator frequency to the frequency synthesizer 210 via control line(s) 257.

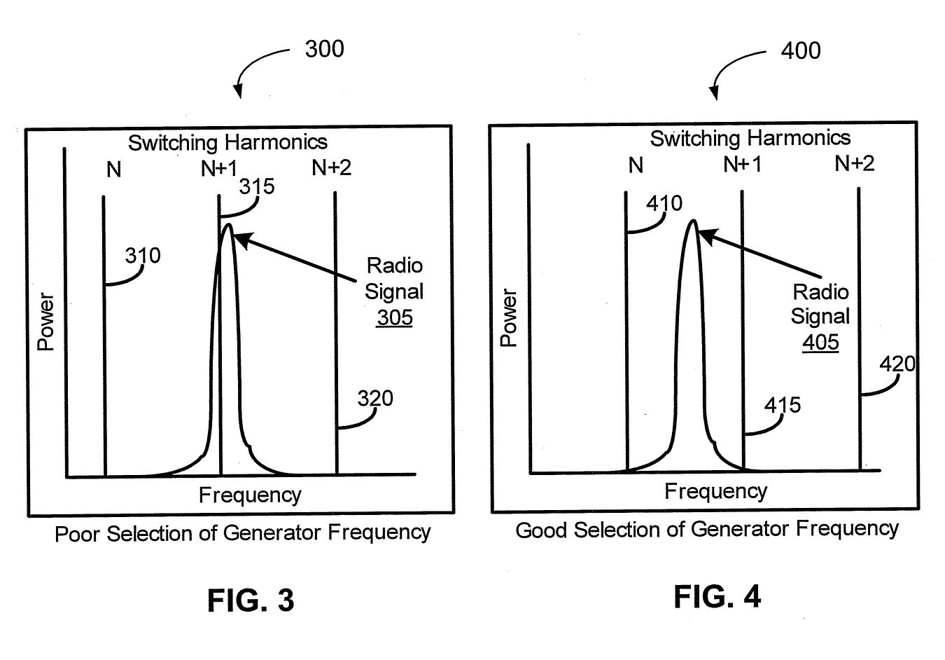

The frequency synthesizer 210 receives the generated clock signals and instructions from the frequency generator 205 and the computing device 220, respectively, and synthesize the generator frequencies based on the received clock signal and instructions. The frequency synthesizer 210 transmits the generator frequencies to the switching regulator 215, computing device 220, cellular transceiver, Wi-Fi transceiver, Bluetooth transceiver, and a global positioning system (GPS) receiver, using lines 213, 217, 219, respectively. The switching regulator 215 receives voltage from V_in via line 250 and provides V_out via line 255 based primarily on an internal or external reference voltage (not shown) and the voltage from V_in. The location of peaks in the interference spectrum of the switching regulator is controlled primarily by the received generator frequency at line 213. The frequency selection manager 235 is further described in relations to FIGS. 3-7.

FIG. 3 is a power-versus-frequency chart that illustrates electromagnetic interference as a result of poor selection of generator frequency that a target device 120 can detect according to one embodiment of the disclosure. The frequency selection manager 235 can determine the switching harmonics 310, 315, 320 with respect to the radio signal 305 and whether the switching harmonics 310, 315, 320 interfere with the radio signal 305. In this case, the switching harmonic 315 interferes with the radio signal 305.

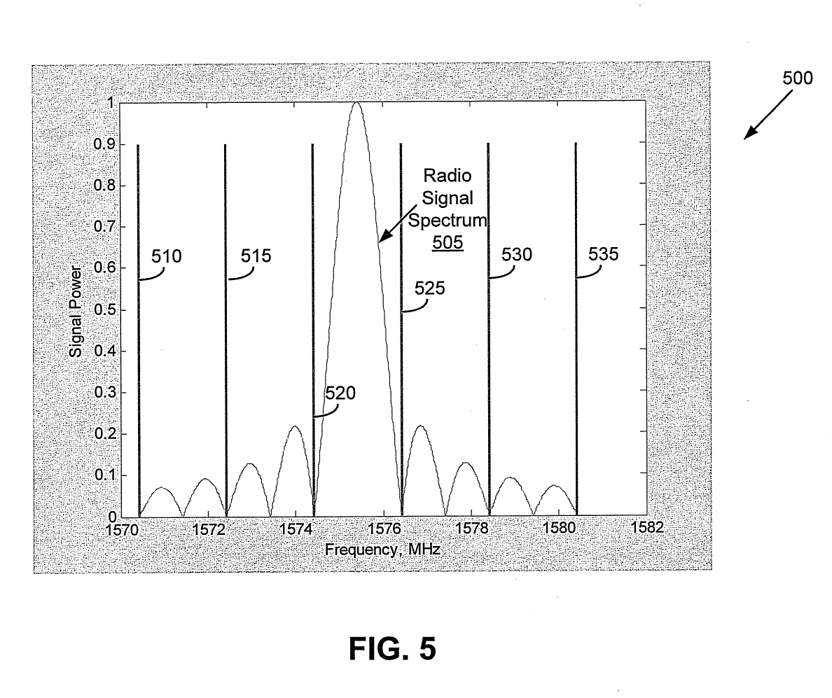

FIG. 4 is a power-versus-frequency chart that illustrates minimum (or zero) electromagnetic interference as a result of good selection of generator frequency in which a target device 120 minimized or eliminated the electromagnetic interference using a frequency selection manager 235, such as that shown in FIG. 2. The frequency selection manager 235 can select the switching harmonics 410, 415, 420 of the generator frequency to avoid the radio band(s) 405 of interest. It may sometimes be the case that the bandwidth of the radio band 405 of interest is smaller than the generator frequency. In this case, if the generator frequency is controlled by an accurate frequency source such as the crystal oscillator 205 and frequency synthesizer 210, then the generator frequency can be arranged so that the switching harmonics 410, 415, 420 are optimally arranged away from the radio band 405 of interest. This can be useful as technology advances and the generator frequency becomes higher and thus the harmonic spacing becomes larger.

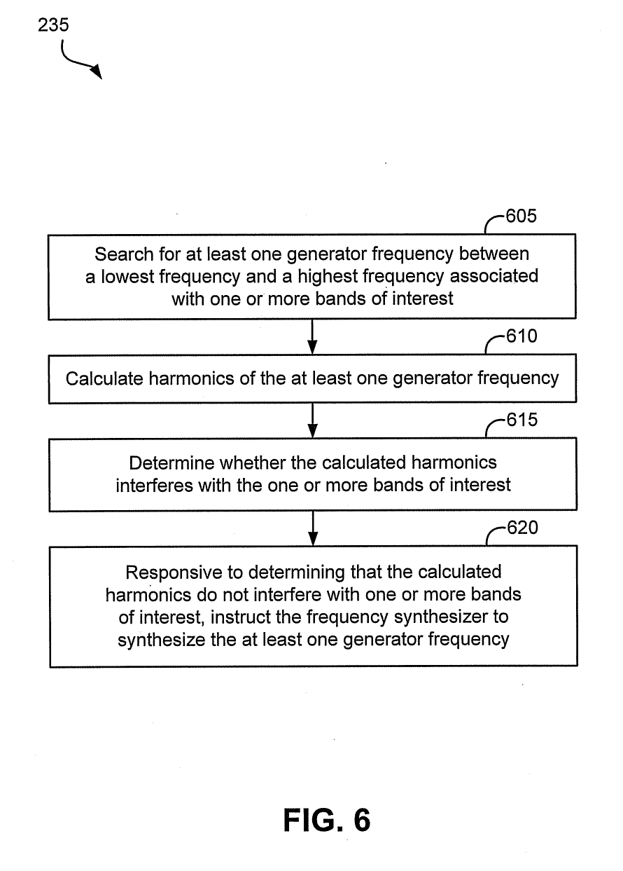

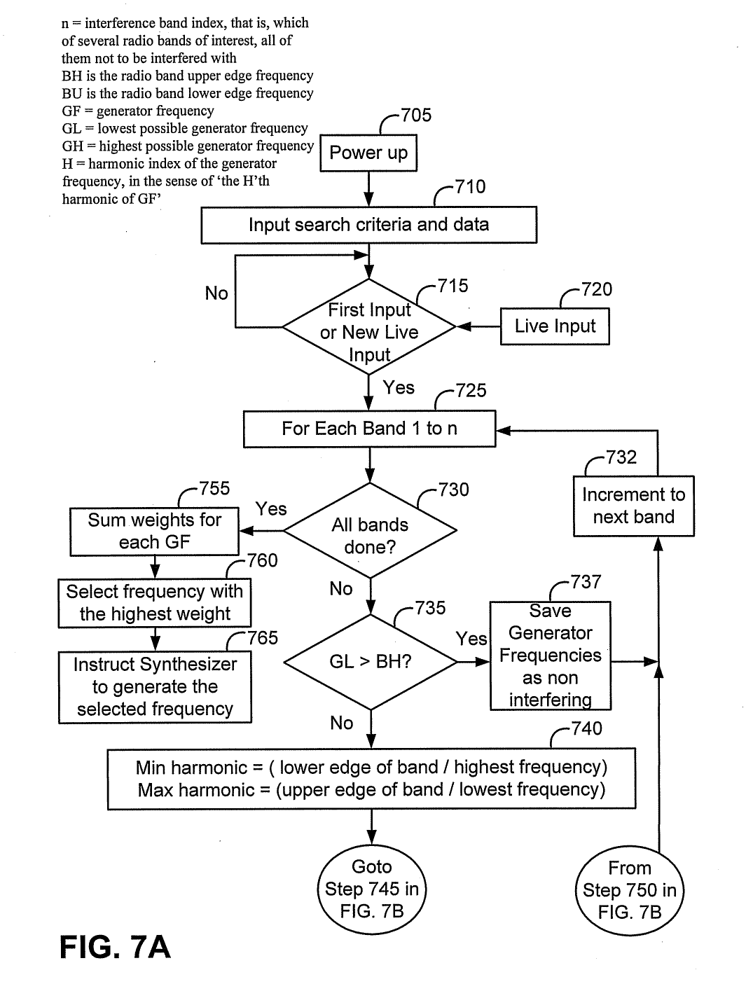

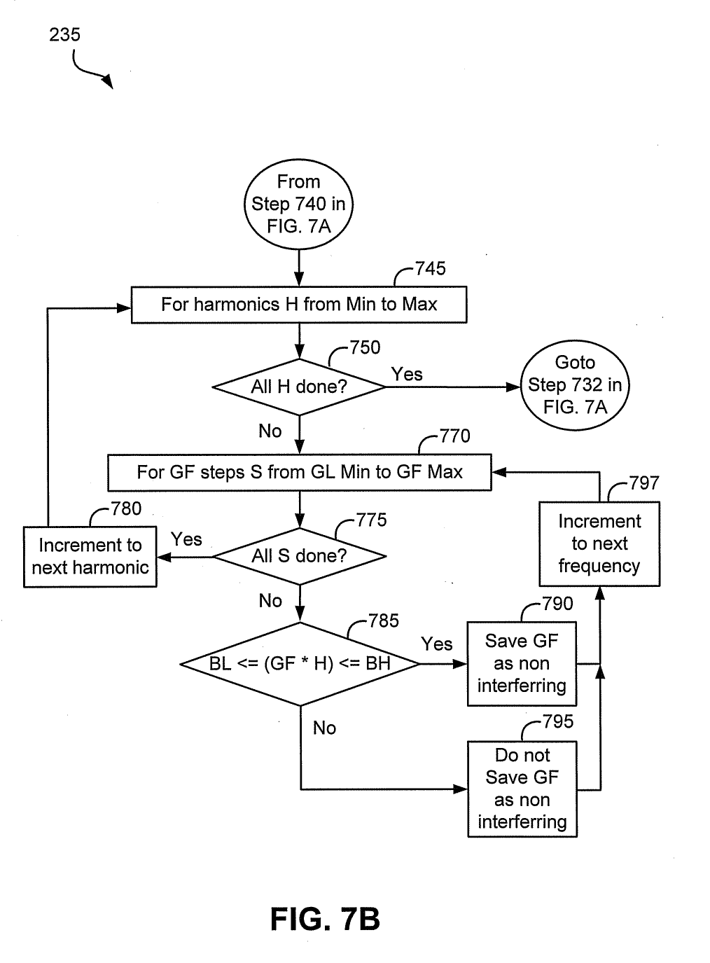

FIG. 5 is a signal power-versus-frequency chart that illustrates minimum (or zero) electromagnetic interference as a result of good selection of generator frequency in which a target device 120 has selected frequencies to fall into spectral nulls of a radio signal spectrum 505 using a frequency selection manager 235, such as that shown in FIG. 2. Sometimes it is not possible to move the harmonics out of the radio frequency band, however the in-band interferences are generally not all equally bad irrespective of frequency. In this regard, the frequency selection manager 235 can select the generator frequency having switching harmonics 510, 515, 520, 525, 530, 535 that fall into spectral nulls of the radio signal spectrum 505, if such spectral nulls exist. In this case, the generator frequency should be precisely controlled and synthesized. The switching interference can be made nearly invisible to the receiver, if it is not too strong. For example, if the generator frequency is 2.046 MHz or a harmonic thereof, it is advantageous to a GPS system performance because GPS signal nulls are located at harmonics of that frequency. The frequency selection manager 235 is further described in relations to FIGS. 6-7 that illustrate exemplary flow diagrams of the frequency selection manager 235.

FIG. 6 is a high-level flow diagram that illustrates an embodiment of the architecture, functionality, and/or operation of a frequency selection manager 235, such as that shown in FIG. 2, that selects a frequency to minimize electromagnetic interference. Beginning with steps 605 and 610, the frequency selection manager 235 searches for at least one generator frequency between a lowest frequency and a highest frequency associated with one or more radio bands of interest and calculates harmonics associated with the searched generator frequency, respectively. The harmonics include the fundamental frequency (e.g., n=1) of the generator frequency. In step 615, the frequency selection manager 235 determines whether the calculated harmonics interfere with the one or more radio bands of interest. The interference is based on harmonics of the generator frequency which fall into the sensitive band. In step 620, responsive to determining that the calculated harmonics do not interfere with one or more radio bands of interest, the frequency selection manager 235 instructs the frequency synthesizer 210 to synthesize the searched generator frequency, respectively.

FIGS. 7A-B are flow diagrams that illustrate an embodiment of the architecture, functionality, and/or operation of a frequency selection manager 235, such as that shown in FIG. 2. Beginning with steps 705 and 710, the computing device 220 powers up, and then the frequency selection manager 235 inputs search criteria and data generally via a user input or pre-stored information, respectively. The search criteria includes, but is not limited to,
a) frequency step size of the frequency synthesizer 210,
b) lowest and highest frequency of the frequency synthesizer 210,
c) sensitive bands each identified by center frequency and bandwidth for which it is desired to have no harmonics of the synthesizer output, and
d) the priority weight factor of each sensitive band.

The priority weight allows for an optimum search in cases where there are no synthesizer frequencies which do not interfere with any of the requested sensitive bands. In this case, the weight factors can provide the best compromise to be found. Alternatively or additionally, the sensitive bands may each be identified by lower frequency limit and upper frequency limit, as well as priority weight factors.

In step 715, the frequency selection manager 235 determines whether it has received a first input search criteria and data or new live input from step 720. Such new live input includes at least the following: new band input from a host processor, band lower edges, band upper edges, and band priority weights, among others. Alternatively or additionally, the bands may be identified by band center frequency and band width, being equivalent information to the upper and lower band edge frequencies. It is also allowed that there may be only one sensitive band. Responsive to determining that the frequency selection manager 235 received the first input search criteria and data or new live input, the frequency selection manager 235 selects the lowest frequency and a band of interest, or the only band if there is just one, and begins with the synthesizer lower limit frequency GL.

Responsive to determining that the frequency selection manager 235 did not receive the first input search criteria and data or new live input, the frequency selection manager 235 continues to search for the first input search criteria and data or new live input. The frequency selection manager 235 in step 725 processes each band, if there is more than one, between a first band to a Nth band, starting with the first band, e.g., lowest band.

In step 730, the frequency selection manager 235 determines whether all of the one or more radio bands of interest have been processed. Responsive to determining that all of the one or more radio bands of interest have not been processed, the frequency selection manager 235 in step 735 calculates a lowest generator harmonic associated with the lowest frequency. The frequency selection manager 235 determines whether the lowest generator harmonic associated with the lowest frequency is above an upper band edge associated with selected band of interest. In this case, all synthesizer frequencies are good for that radio band.

Responsive to determining that the lowest generator harmonic associated with the lowest frequency is above the upper band edge associated with selected band of interest, the frequency selection manager 235 in step 737 can save the entire synthesizer range as non-interfering and associate the save frequencies as generator frequencies with a band priority weight. The frequency selection manager 235 in step 732 increments to the next band and goes to step 725. It should be noted that steps 755, 760, 765 will be described later in the specification.

Responsive to determining that the lowest generator harmonic associated with the lowest frequency is not above the upper band edge associated with selected band of interest, the frequency selection manager 235 in step 740 calculates a minimum harmonic by dividing a band lower edge associated with the selected band of interest by the highest synthesizer frequency. Also, the frequency selection manager 235 calculates a maximum harmonic by dividing a band upper edge associated with the selected band of interest by the lowest synthesizer frequency. The frequency selection manager 235 in step 745 processes the harmonics between the calculated minimum harmonic and calculated maximum harmonic, starting with the calculated minimum harmonic.

Responsive to determine that the harmonics between the calculated minimum harmonic and calculated maximum harmonic have not been processed, the frequency selection manager 235 in step 770 processes the frequencies between the lowest generator frequency which can have a harmonic in-band and the maximum generator frequency which may have a harmonic in-band, starting with the lowest frequency. Responsive to determining that the frequencies have not been processed in step 770, the frequency selection manager 235 in step 785 determines whether the harmonic of the generator frequency falls into the selected radio band of interest, e.g, between the band lower edge and the band upper edge. Responsive to determining that the harmonic of the generator frequency falls into the selected band of interest, the frequency selection manager 235 in step 790 saves the generator frequency as interfering.

Responsive to determining that the harmonic of the generator frequency does not fall into the selected band of interest, the frequency selection manager 235 in step 795 saves the generator frequency as non-interfering. In step 797, the frequency selection manager 235 increments to the next frequency using, for example, the frequency step size, and goes to step 770. Steps 770, 775, 785, 790 (or 795), and 797 repeat until the frequency selection manager 235 processes the generator frequencies between the lowest frequency and the maximum generator frequency.

Responsive to determining that the generator frequencies between the lowest frequency to the maximum generator frequency have been processed, the frequency selection manager 235 in step 780 increments to the next harmonic number and goes to step 745. Steps 745, 750, 770, 775, 785, 790 (or 795), and 797 repeat until the harmonics between the calculated minimum harmonic and calculated maximum harmonic are processed. Responsive to determining that all of the harmonics between the calculated minimum harmonic and calculated maximum harmonic have been processed, the frequency selection manager 235 in step 732 increments to the next band, if any, and goes to step 725. Steps 725, 730, 735, 740 (or 737), 745, 750, 770, 775, 785, 790 (or 795), and 797 repeat until the bands between the first band and the Nth band, if more than one are specified, are processed.

In steps 755, 760, and 765, responsive to determining that the bands between the first band and the Nth band have been processed, the frequency selection manager 235 sums the weights for each generator frequency, selects a frequency with the highest weight, and instructs the frequency synthesizer 210 to generate the selected frequency, respectively.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

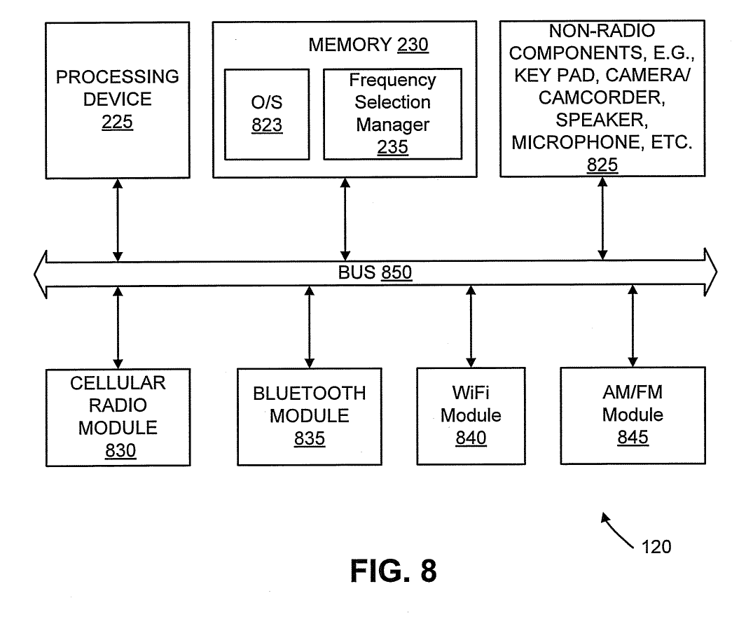

FIG. 8 is a block diagram illustrating an exemplary architecture for a target device 120, such as that shown in FIG. 2. In this example, the architecture of the target device 120 is similar to the architecture of a cellular phone. As indicated in FIG. 8, the target device 120 comprises a processing device 225, memory 230, non-radio components 825, cellular radio module 830, Bluetooth module 835, Wi-Fi module 840, and AM/FM module 845, each of which is connected to a local interface 850. The processing device 225 can include any custom made or commercially available processor, a central processing unit (CPU) or an auxiliary processor among several processors associated with a generic computer, a semiconductor based microprocessor (in the form of a microchip), or a macroprocessor. The memory 230 can include any one or a combination of volatile memory elements (e.g., random access memory (RAM, such as DRAM, SRAM, etc.)) and nonvolatile memory elements (e.g., ROM, hard drive, tape, CDROM, etc.).

The non-radio components 825 can include, but not limited to, a key-pad, camera, camcorder, speaker, microphone, and display, among others. The radio modules 830, 835, 840, 845 include any custom made or commercially available chipsets associated with cellular radio, Bluetooth, Wi-Fi, and AM/FM radio.

The memory 230 normally comprises various programs (in software and/or firmware) including an operating system (O/S) 823 and a frequency selection manager 235. The O/S 823 controls the execution of programs, and provides scheduling, input-output control, file and data management, memory management, and communication control and related services. The frequency selection manager 235 facilitates controlling a frequency synthesizer 210 (FIG. 2) to minimize electromagnetic interference at the target device 120. The operations of the frequency selection manager 235 were previously described above.

The systems and methods disclosed herein can be implemented in software, hardware, or a combination thereof. In some embodiments, the system and/or method is implemented in software that is stored in a memory and that is executed by a suitable microprocessor (μP) situated in a computing device 220 (FIG. 2). However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example, but not limited to, a system or propagation medium that is based on electronic, magnetic, optical, electromagnetic, infrared, or semiconductor technology.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. An electronic device that minimizes electromagnetic interference comprising:
a frequency generator that generates clock signals;
a computing device that selects at least one generator frequency that minimizes or eliminates electromagnetic interference based on one or more radio bands of interest; the computing device being designed to send instructions associated with synthesizing the at least one generator frequency, and
a frequency synthesizer that receives the generated clock signals and instructions from the frequency generator and the computing device, respectively, and synthesize the at least one generator frequency based on the received clock signal and instructions.

2. The electronic device as defined in claim 1, further comprising clock-based devices that use clock signals to operate, the clock-based devices being designed to receive the at least one generator frequency from the frequency synthesizer, the clock-based devices including at least one of the following: a processing device, memory, switching regulator, cellular transceiver, Wi-Fi transceiver, Bluetooth transceiver, a global positioning system (GPS) receiver, frequency modulation (FM) receiver, and amplitude modulation (AM) receiver.

3. The electronic device as defined in claim 1, wherein the at least one generator frequency includes arbitrary numbers of simultaneous different center frequencies that minimize or eliminate electromagnetic interference at the one or more radio bands of interest.

4. The electronic device as defined in claim 1, wherein the computing device selects the at least one generator frequency using weighting factor for each of the one or more radio bands of interest, based on predetermined priorities related to the one or more radio bands of interest, to provide optimal weighted solution.

5. The electronic device as defined in claim 1, wherein the computing device selects the at least one generator frequency based on specifiable upper and lower generator frequencies for respective clock-based devices that use clock signals to operate.

6. The electronic device as defined in claim 1, wherein the electronic device includes at least one of the following: a laptop, cell phone, personal digital assistant (PDA), satellite, Bluetooth device, wireless router, global positioning system (GPS) receiver.

7. The electronic device as defined in claim 6, wherein the one or more radio bands of interest include frequencies that the electronic device is transmitting and/or receiving.

8. The electronic device as defined in claim 1, wherein the frequency generator includes a crystal oscillator and the computing device includes a microprocessor.

9. The electronic device as defined in claim 1, wherein the computing device selects the at least one generator frequency by using the following electrical components:
a processing device; and
memory including a frequency selection manager which has the instructions that are executed by the processing device, the instructions including the following logics:
search for the at least one generator frequency between a lowest frequency and a highest frequency associated with the one or more radio bands of interest;
calculate harmonics associated with each searched generator frequency, the harmonics being a fundamental frequency of the generator frequency;
determine whether the calculated harmonics interfere with the one or more radio bands of interest; and
responsive to determining that the calculated harmonics do not interfere with the one or more radio bands of interest, instruct the frequency synthesizer to synthesize the searched generator frequency.

10. A computing device comprising:
a processing device; and
memory having a frequency selection manager that includes instructions to perform the following logics:
select at least one generator frequency that minimizes or eliminates electromagnetic interference based on one or more radio bands of interest, and
send instructions associated with synthesizing at least one generator frequency.

11. The computing device as defined in claim 10, wherein the computing device sends the instructions to a frequency synthesizer that receives clock signals from a frequency generator, the frequency synthesizer being designed to synthesize the at least one generator frequency based on the received clock signal and instructions.

12. The computing device as defined in claim 10, wherein the frequency selection manager is designed to select the at least one generator frequency for clock-based devices that use clock signals to operate, the clock-based devices being designed to receive the at least one generator frequency from a frequency synthesizer, the clock-based devices including at least one of the following: a processing device, memory, switching regulator, cellular transceiver, WiFi transceiver, Bluetooth transceiver, a global positioning system (GPS) receiver, frequency modulation (FM) receiver or transmitter, and amplitude modulation (AM) receiver.

13. The computing device as defined in claim 12, wherein the one or more radio bands of interest include frequencies that the clock-based devices are operating.

14. The computing device as defined in claim 10, wherein the at least one generator frequency includes arbitrary numbers of simultaneous different center frequencies that minimize or eliminate electromagnetic interference at the one or more radio bands of interest.

15. The computing device as defined in claim 10, wherein the frequency selection manager selects the at least one generator frequency using weighting factor for each of the one or more radio bands of interest, based on predetermined priorities related to the one or more radio bands of interest, to provide optimal weighted solution.

16. The computing device as defined in claim 10, wherein the frequency selection manager selects the at least one generator frequency based on specifiable upper and lower generator frequencies for respective clock-based devices that use clock signals to operate.

17. The computing device as defined in claim 10, wherein the frequency selection manager includes the following logics:
search for the at least one generator frequency between a lowest frequency and a highest frequency associated with the one or more radio bands of interest;
calculate harmonics associated with the searched generator frequency;
determine whether the calculated harmonics interfere with the one or more radio bands of interest; and
responsive to determining that the calculated harmonics do not interfere with the one or more radio bands of interest, instruct a frequency synthesizer to synthesize the searched generator frequency.

18. A method comprising the steps of:
selecting at least one generator frequency that minimizes or eliminates electromagnetic interference based on one or more radio bands of interest, and
sending instructions associated with synthesizing at least one generator frequency.

19. The method as defined in claim 18, wherein selecting the at least one generator frequency includes using weighting factor for each of the one or more radio bands of interest, based on predetermined priorities related to the one or more radio bands of interest, to provide optimal weighted solution.

20. The method as defined in claim 18, wherein selecting the at least one generator frequency is based on specifiable upper and lower generator frequencies for respective clock-based devices that use clock signals to operate.

21. The method as defined in claim 18, further comprising:
searching for the at least one generator frequency between a lowest frequency and a highest frequency associated with the one or more radio bands of interest;
calculating harmonics associated with the searched generator frequency;
determining whether the calculated harmonics interferes with the one or more radio bands of interest; and
responsive to determining that the calculated harmonics do not interferes with the one or more radio bands of interest, instructing a frequency synthesizer to synthesize the searched generator frequency.
